(19) United States
(12) Patent Application Publication
(10) Pub. No.: US 2008/0306858 A1
(43) Pub. Date: Dec. 11, 2008

(54) SYSTEM AND METHOD FOR ENABLING HEDGING CUSTOMERS TO LOCK FORWARD POSITIONS WITH CUSTOMER-FRIENDLY PAYMENT OPTIONS

(75) Inventors: Robert M. Fell, Summerland, CA (US); Scott Painter, Bel Air, CA (US); Michael R. Bonsignore, Seattle, WA (US); Brian P. Reed, Southlake, TX (US); Gary A. Magnuson, Corpus Christi, TX (US)

Correspondence Address: SPRINKLE IP LAW GROUP, 1301 W. 25TH STREET, SUITE 408, AUSTIN, TX, 78705, US

(73) Assignee: Pricelock, Inc., Irving, TX (US)

(21) Appl. No.: 12/030,041

(22) Filed: Feb. 12, 2008

Related U.S. Application Data
(60) Provisional application No. 60/900,844, filed on Feb. 12, 2007.

(51) Int. Cl. G06Q 40/00

(52) U.S. Cl. 705/37

(57) ABSTRACT

In some embodiments, a method includes providing a loan or line of credit (LOC) to a purchaser to financing the cost of purchasing a retail commodity price protection contract. A new financial instrument is created bundling the loan or LOC and the retail commodity price protection contract. The method also includes allowing the purchaser to draw on a trust (that may have been created with proceeds from the loan) to purchase the retail commodity. The retail commodity price protection contract may specify a forward position, which may be selected by the customer, associated with the retail commodity. According to the forward position specified in the retail commodity price protection contract, a price protection service provider provides price protection to the customer against variability in the price of the retail commodity. The loan or LOC may be provided by a financial institution or the price protection service provider.

### RELATED INFORMATION

This application claims priority to U.S. Patent Application No. 60/900,844, entitled “System And Method For Enabling Hedging Customers To Lock Forward Positions With Customer-Friendly Payment Options,” filed on Feb. 12, 2007, by Fell et al., and which is incorporated herein as if set forth in full.

### TECHNICAL FIELD

This patent application relates generally to hedging services. More particularly, this application relates to the creation of new financial instruments which offer payment flexibility to customers of a hedging service.

### BACKGROUND

Many commodities fluctuate in price on a regular basis. The volatility of these fluctuations depends heavily on a variety of factors, including supply and demand, or variables associated with the supply and demand. Disruptions in the supply of these commodities such as those caused by world events, natural disasters, etc. may cause their price to change markedly in a relatively short amount of time. These price changes can be quite noticeable, as these types of products are extensively consumed and fluctuations in the price of these products may occur relatively rapidly.

The severity of the effects of these price changes is usually tied directly to the amount of the product consumed. Take gasoline as an example. While individual consumers are certainly affected by spikes in gasoline prices, these effects may be even more pronounced with regard to large purchasers of gasoline. More specifically, large purchasers such as businesses which rely on a fleet of vehicles to conduct their day-to-day operations may be severely financially strained by an increase in the price of gasoline. Thus, relatively frequent fluctuations in price can make anticipating future expenses for a commodity very difficult, creating budgeting and accounting issues for large purchasers of the commodity.

There are currently a variety of schemes through which commodities can be purchased. One example of these types of schemes is a fuel card, which is similar to the concept of a gift card. A consumer may purchase a fuel card such that the fuel card has an associated value. Whenever the fuel card is used to purchase fuel at a retail point of sale location, however, the retail price at the time of purchase may be used to subtract value from the fuel card. Thus, the consumer is not protected from adverse fluctuations in the market price of fuel.

Some purchasing systems have been introduced in certain industry segments in an effort to address this issue. For example, there are certain schemes which allow a consumer to purchase a good or service and take later delivery, in whole or in part, such as purchasing a quantity of fuel which is physically deposited in a storage tank for future at will consumption. In other words, the physical product itself has to be ordered and deposited into a storage facility, which has a limited capacity.

Other schemes have been introduced whereby an individual consumer or a business consumer such as a fleet manager may purchase a quantity of fuel at the then prevailing retail price such that an account associated with the consumer is credited with the amount purchased. At this point, the fuel has not actually been delivered but a quantity is held on reserve that can be redeemed in part or in whole at a variety of locations. However, the consumer has to pay for the entire amount in advance and committed to the quantity of the fuel thus pre-purchased.

### SUMMARY

Embodiments disclosed herein allow consumers to obtain price protection against adverse fluctuations in the price of a commodity. Some embodiments are directed to the creation of new financial instruments that offer additional payment flexibility for current and potential customers seeking protection against variability in the price for a commodity. One such embodiment would be the creation of a loan or line of credit in partnership with a financial institution such that a customer would be able to enter into a long-term hedging agreement with a hedging service provider without the full outlay of pre-purchasing fuel. In some embodiments, this arrangement enables a hedging customer to lock a forward position with no cash upfront. One embodiment of such a hedging service is provided by the Pricelock system described in U.S. patent application Ser. No. 11/705,571, filed on Feb. 12, 2007, by Fell et al., entitled “METHOD AND SYSTEM FOR PROVIDING PRICE PROTECTION FOR COMMODITY PURCHASING THROUGH PRICE PROTECTION CONTRACTS,” which is incorporated herein as if set forth in full.

In some embodiments, methods are provided in which a price protection service associated with a retail commodity is provided in consideration for at least a portion of a loan. The service includes providing either a forward position or an option contract in the commodity. Some, or all, of the loan is used to create a trust from which funds are drawn when the purchaser obtains some of the price-protected commodity. When the purchaser defaults on servicing the loan, the purchaser may be prevented from drawing on the trust and using the price protection service. The funds in the trust may also be given back to the lender (who may have been given a security interest in the trust) when a default occurs. When the purchaser does not use all of the price protection service, the purchaser may be allowed to rollover the un-used portion of the service; receive a refund on the un-used portion; or novate the un-used portion. In some embodiments, the purchaser may be introduced to a financial institution to facilitate the making of the loan.

In some embodiments, methods of financing the purchase of a price protection service are provided. The methods include providing a loan to purchase of a price protection service to finance a portion of the purchase. The methods also include allowing a purchaser, which is an end consumer in some embodiments, to draw on a trust associated with the price protection service to obtain the price-protected commodity as long as the purchaser services the loan. When the purchaser defaults on the service of the loan, the methods include preventing the purchaser from drawing on the trust to obtain the price-protected commodity. The lender may receive a security interest in the trust so that, in some embodiments, when a purchaser defaults on the loan (which may have been used to create the trust), the lender receives any funds remaining in the trust that are associated with the defaulting purchaser. In some methods, the lender and the service provider form a partnership and introduce customers to each other. Some embodiments of the price protection service include providing either a forward position or an option contract in the commodity to the purchaser. The purchaser may be selected based on the purchaser's pattern of consuming the commodity or on having a cash flow position which is affected by the commodity price. As part of underwriting the loan, the lender may assess the credit risk of the purchaser.

Systems for financing the purchase of a price protection service which is associated with a retail commodity are provided in some embodiments. Some such systems include a price protection service provider, a financial institution, and a trust (in which the financial institution may have a security interest). The financial institution provides a loan to a purchaser of the service to finance at least a portion of the service. When the purchaser obtains the price-protected commodity, a draw on the trust occurs. In some embodiments, the service provider serves as the financial institution. In some embodiments, the service provider and the financial institution can be partners.

Embodiments of the disclosure provide many advantages including allowing a financial institution to issue cash collateralized loans to consumers for purchasing price protection services associated with retail commodities which exhibit price volatility. Thus, the financial institution can create loans based upon credit risks associated with the debtors (retail commodity consumers in some embodiments) rather than based up the institution's (potentially incomplete) understanding of the price volatility of the commodity. The consumers, for their part, may be allowed to finance the purchase of price protection services which can include pro-purchasing quantities of the commodity. Price protection service providers, for their part, may enjoy a larger customer base than might otherwise be the case while being able to focus on understanding the volatility of the commodity rather than the credit worthiness of the consumers.

Other features, advantages, and objects of the disclosure will be better appreciated and understood when considered in conjunction with the following description and the accompanying drawings.

### BRIEF DESCRIPTION OF THE FIGURES

A more complete understanding of the disclosure and the advantages thereof may be acquired by referring to the following description, taken in conjunction with the accompanying drawings in which like reference numbers generally indicate like features and wherein:

FIG. 1 is a flowchart illustrating a method of financing the purchase of price protection services associated with a retail commodity.

FIG. 2 illustrates a system for financing the purchase of price protection services associated with a retail commodity.

FIG. 3 is a flowchart illustrating another method of financing the purchase of price protection services associated with a retail commodity.

FIG. 4 is a representation of a financial institution strike price matrix.

### DETAILED DESCRIPTION

Preferred embodiments of the disclosure are illustrated in the FIGURES, like numerals being used to refer to like and corresponding parts of the various drawings. Embodiments disclosed herein are directed to the creation of new financial instruments that offer additional payment flexibility for current and potential customers of an innovative hedging service. One such embodiment would be the creation of a loan or line of credit in partnership with a financial institution such that a customer would be able to enter into a long-term hedging agreement with the hedging service provider without the full outlay associated with pre-purchasing fuel (enabling a hedging customer to lock a forward position with no cash upfront in some embodiments). Some embodiments of such a hedging services may be provided by an entity implementing a system and method disclosed in U.S. patent application Ser. No. 11/705,571, entitled “METHOD AND SYSTEM FOR PROVIDING PRICE PROTECTION FOR COMMODITY PURCHASING THROUGH PRICE PROTECTION CONTRACTS,” filed on Feb. 12, 2007, by Fell et al., which is incorporated herein as if set forth in full.

Within this disclosure, the term “commodity” refers to an article of commerce—an item that can be bought and sold freely on a market. It may be a product which trades on a commodity exchange or spot market and which may fall into one of several categories, including energy, food, grains, and metals. Currently, commodities that can be traded on a commodity exchange include, but are not limited to, crude oil, light crude oil, natural gas, heating oil, gasoline, propane, ethanol, electricity, uranium, lean hogs, pork bellies, live cattle, feeder cattle, wheat, corn, soybeans, oats, rice, cocoa, coffee, cotton, sugar, gold, silver, platinum, copper, lead, zinc, tin, aluminum, titanium, nickel, steel, rubber, wool, polypropylene, and so on. Note that a commodity can refer to tangible things as well as more ephemeral products. Foreign currencies and financial indexes are examples of the latter. For example, positions in the Goldman Sachs Commodity Index (GSCI) and the Reuters Jefferies Consumer Research Board Index (RJCRB Index) can be traded as a commodity. What matters is that something be exchanged for the thing. New York Mercantile Exchange (NYMEX) and Chicago Mercantile Exchange (CME) are examples of a commodity exchange. Other commodities exchanges also exist and are known to those skilled in the art.

In a simplified sense, commodities are goods or products with relative homogeneousness that have value and that are produced in large quantities by many different producers; the goods or products from each different producer are considered equivalent. Commoditization occurs as a goods or products market loses differentiation across its supply base. As such, items that used to carry premium margins for market participants have become commodities, of which crude oil is an example. However, a commodity generally has a definable quality or meets a standard so that all parties trading in the market will know what is being traded. In the case of crude oil, each of the hundreds of grades of fuel oil may be defined. For example, West Texas Intermediate (WTI), North Sea Brent Crude, etc. refer to grades of crude oil that meet selected standards such as sulfur content, specific gravity, etc., so that all parties involved in trading crude oil know the qualities of the crude oil being traded. Motor fuels such as gasoline represent examples of energy-related commodities that may meet standardized definitions. Thus, gasoline with an octane grade of 87 may be a commodity and gasoline with an octane grade of 93 may also be a commodity, and they may demand different prices because the two are not identical—even though they may be related. Those skilled in the art will appreciate that other commodities may have other ways to define a quality. Other energy-related commodities that may have a definable quality or that meet a standard include, but are not limited to, diesel fuel, heating oils, aviation fuel, and emission credits. Diesel fuels may generally be classified according to seven grades based in part on sulfur content, emission credits may be classified based on sulfur or carbon content, etc.

Historically, risk is the reason exchange trading of commodities began. For example, because a farmer does not know what the selling price will be for his crop, he risks the margin between the cost of producing the crop and the price he achieves. In some cases, investors can buy or sell commodities in bulk through futures contracts. The price of a commodity is subject to supply and demand.

A commodity may refer to a retail commodity that can be purchased by a consuming public and not necessarily the wholesale market only. One skilled in the art will recognize that embodiments disclosed herein may provide means and mechanisms through which commodities that currently can only be traded on the wholesale level may be made available to retail level for retail consumption by the public. One way to achieve this is to bring technologies that were once the private reserves of the major trading houses and global energy firms down to the consumer level and provide tools that are applicable and useful to the retail consumer so they can mitigate and/or manage their measurable risks involved in buying/selling their commodities. One example of an energy related retail commodity is motor fuels, which may include various grades of gasoline. For example, motor fuels may include 87 octane grade gasoline, 93 octane grade gasoline, etc as well as various grades of diesel fuels. Other examples of an energy related retail commodity could be jet fuel, heating oils, electricity or emission credits such as carbon offsets. Other retail commodities are possible and/or anticipated.

While a retail commodity and a wholesale commodity may refer to the same underlying good, they are associated with risks that can be measured and handled differently. One reason is that, while wholesale commodities generally involve sales of large quantities, retail commodities may involve much smaller transaction volumes and relate much more closely to how and where a good is consumed. The risks associated with a retail commodity therefore may be affected by local supply and demand and perhaps different factors. Within the context of this disclosure, there is a definable relationship between a retail commodity and the exposure of risks to the consumer. This retail level of the exposure of risks may correlate to the size and the specificity of the transaction in which the retail commodity is traded. Other factors may include the granularity of the geographic market where the transaction takes place, and so on. For example, the demand for heating oil No. 2 in January may be significantly different in the Boston market than in the Miami market.

Before discussing specific embodiments, an embodiment of a hardware architecture for implementing certain embodiments is described herein. One embodiment can include a computer communicatively coupled to a network (the Internet in some embodiments). As is known to those skilled in the art, the computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (such as a mouse, trackball, stylist, etc.), or the like. In various embodiments, the computer has access to at least one database over the network.

ROM, RAM, and HD are computer memories for storing computer-executable instructions executable by the CPU. Within this disclosure, the term “computer-readable medium” is not limited to ROM, RAM, and HD and can include any type of data storage medium that can be read by a processor. In some embodiments, a computer-readable medium may refer to a data cartridge, a data backup magnetic tape, a floppy diskette, a flash memory drive, an optical data storage drive, a CD-ROM, ROM, RAM, HD, or the like.

The functionalities and processes described herein can be implemented in suitable computer-executable instructions. The computer-executable instructions may be stored as software code components or modules on one or more computer readable media (such as non-volatile memories, volatile memories, DASD arrays, magnetic tapes, floppy diskettes, hard drives, optical storage devices, etc. or any other appropriate computer-readable medium or storage device). In one embodiment, the computer-executable instructions may include lines of complied C++, Java, HTML, or any other programming or scripting code.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

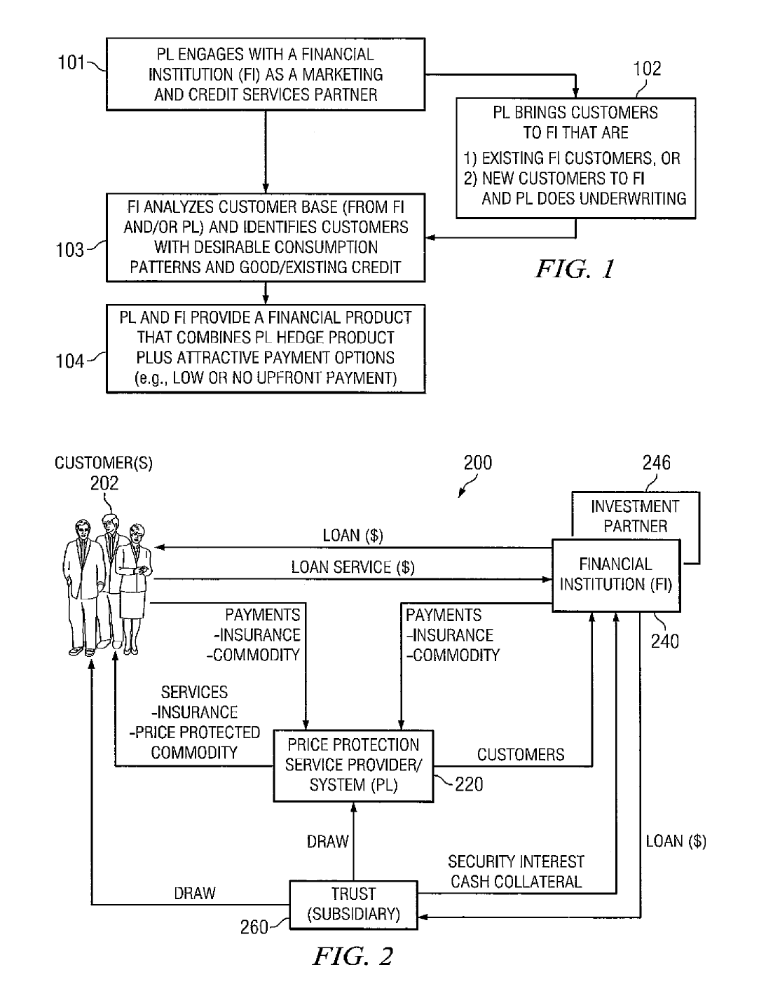

FIG. 1 is a simplified flow diagram representatively depicting, according to one embodiment, a process of allowing customers of a hedging service provider (referred to as “PL”) to lock forward positions with various customer-friendly payment options.

At step 101, PL engages with a financial institution (FI) (a bank, a credit card company, or other commercial credit providers, etc. in some embodiments) as a credit services partner that is capable of extending loans to current and potential hedging customers seeking price protection on certain retail commodities (in some embodiments gasoline).

At step 102, PL brings customers to FI, including existing FI customers and new FI customers (PL does the underwriting for PL customers that are new to FI). More specifically, PL may identify within its own customer base companies that would be potential FI customers or companies that are already customers of the financial institution, but were not previously identified.

At step 103, FI evaluates their existing customer base (from FI and/or PL) to identify customers that have credit facilities in good standing and, in the case of gasoline, one of the following qualifiers:
a. desirable gasoline consumption pattern (in some embodiments, the consumption pattern may be that the customer's annual gasoline consumption is at or above a predetermined value); and
b. cost and/or revenue structure that is directly tied to the cost of vehicle fuel. In some embodiments, the customer's profitability being negatively correlated to the price of fuel is the qualifier.

At step 104, FI offers a loan, either directly to the customer or through PL, that would cover some or all of the cost of pre-purchased retail commodity (in some embodiments, fuel) and price protection (or other PL services). This loan could also be bundled directly with the PL price protection and pre-purchase (offered as a financing option at time of purchase in some embodiments). This would allow PL to offer a range of product options, including:
PL customer buys a year of price protection up-front and in full (no loan).
PL customer buys a year of price protection but only pre-pays two months. The balance is covered by FI in the form of a loan, which may vary in terms as follows:
FI pays PL 10 month balance day one;
PL signs full recourse loan to FI; or
PL customer pays interest and is contracted with FI.
PL customer buys a year of protection with no pre-payment, the entire cost of protection and pre-purchased fuel being covered by the loan from FI.

Moreover, in the case of fuel as the target commodity for price protection, this type of loan would be secured by the fuel or, more specifically, the cash reserves on the pre-purchase of fuel. At origination, FI would transfer cash to PL to cover the cost of the price protection and the pre-purchased fuel. During servicing, FI would require payments directly from the customer, to service the note.

Other than partnering with FI, PL could service the loan in-house. That is, PL may finance this loan on its own, offering low risk and no upfront funding to its customer, provided that two months are prepaid and insurance is paid for. In this embodiment, the two-month payment covers the hedge and the fuel costs. Other reasonable models of protection, such as collateral, higher interest rates, etc. may also be implemented.

Additionally, PL may charge the customer the total interest of the loan, rather than just receiving a commission or other consideration from FI (if FI carries the full loan). In return, the customer enjoys a variety of payment options, such as no cash upfront, in addition to locking a desirable forward position through PL.

With reference now to FIG. 2, system 200 for financing the purchase of price protection services is illustrated. In some embodiments, system 200 includes customer 202, price protection system 220, financial institution 240, and trust 260. Investment partner 246 or price protection system 220 can serve as financial institution 240 in some embodiments. Price protection system 220 and financial institution 240 may introduce their customers 202 to each other to facilitate making loans and purchasing price protection services. Financial institution 240 can make a loan to customer 202 for customer 202 to (pre) purchase price protection services from price protection system 220. System 200 may include trust 260 into which financial institution 240 can deposit some or all of the proceeds of the loan. In some embodiments, financial institution 240 creates trust 260 with a portion of the loan. Funds from the loan may be drawn from trust 260 by price protection system 220 or customer 202 to pay, or pre-pay, for the price protection services provided by price protection system 220. Funds from the loan may also be paid directly to price protection system 200 to pay for the price protection service or to pay for the pre-purchase of a portion of the commodity. Financial institution 240 may have a security interest in trust 260 so that, in some embodiments, if customer 220 defaults with respect to servicing the loan, then trust 260 remits any funds remaining in trust 260 (for the benefit of customer 202) to financial institution 240. System 200 may also be configured so that if customer 202 defaults, system 200 denies customer 202 access to the price protection services offered by price protection system 220. System 200, in some embodiments, may be configured to provide customer 202 a cash-collateralized loan from financial institution 240 or price protection system 220.

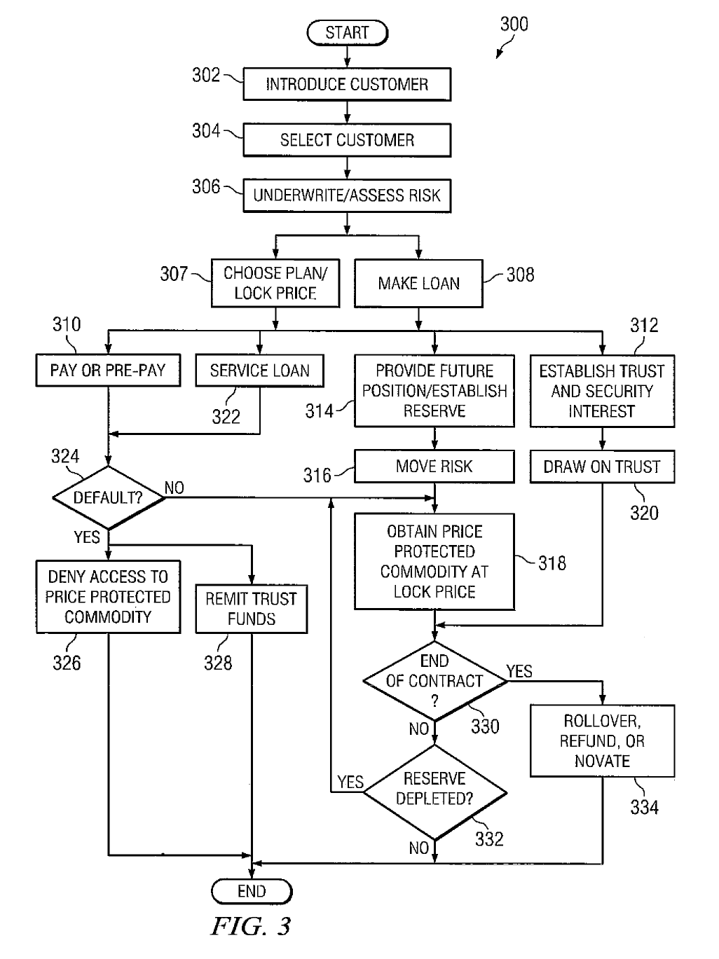

With reference now to FIG. 3, a flowchart illustrates method 300 of financing the purchase of price protection services. At step 302 in some embodiments, either financial institution 240 or price protection service provider 220 may introduce one of their customers 202, or potential customers, to the other party 220 or 240 to facilitate the making of a loan or the purchase of price protection services. Price protection system 220 or financial institution 240 may then select customer 202 for further consideration based on one or more of many factors at step 304. In some embodiments, either price protection system 220 or financial institution 240 could determine that customer 202 has a favorable commodity consumption history or that customer 202 has a cash flow position that the price of the commodity affects. At step 306, either financial institution 240 or price protection service provider 220 could underwrite the loan including, in some embodiments, assessing the credit risk (or worthiness) associated with customer 202. At a convenient time in method 300, various price protection contracts and financing packages may be presented to customer 202.

At some point, at step 307 in some embodiments, customer 202 (a fleet manager in some embodiments) may choose to obtain one of the price protection contracts one of the terms of which is a lock price (to be discussed herein). An obtainment cost may be associated with some of the price protection contracts. Furthermore, operators of price protection system 220 may desire to obtain pre-payment for at least a portion of the quantity of the commodity (fuel in some embodiments) which customer 202 has the right to buy under some price protection contracts. In some embodiments, the price protection contract could give customer 202 the right to purchase a thousand gallons of fuel at the lock price $3.00 per gallon. In these circumstances, the operators of price protection service system 220 may find it desirable to obtain at least a portion of the three thousand dollars in advance. However, in certain embodiments, this pre-payment amount may not be obtained. To that end, a variety of options or payment methodologies may be utilized to allow customer 202 to pay for some or all of the costs associated with obtaining a desired price protection contract.

In some embodiments, customer 202 may have an account on price protection system 220 where the account may be associated with a credit card and the cost billed to the credit card. Similarly, a debit card may be used in substantially the same manner. A wire transfer from customer 202 to a bank account associated with price protection system 220 or operators of price protection system 220 (an account at investment partner 246 in some embodiments) may also be used to pay for any associated costs. It will be appreciated that almost any form of payment may be utilized to pay for costs associated with obtaining a particular price protection contract.

In some embodiments, at step 308, a loan or line of credit from a financial institution (which may or may not be identical to financial institution 120) may be extended to the entity for which customer 202 is obtaining the price protection contract. In some embodiments, customer 202 may obtain the price protection contract via a loan or line of credit and without any up front payments. Operators of price protection system 220 may facilitate customer 202 obtaining the line of credit by engaging financial institution 240 to provide financial services for customer 202. Operators of price protection system 220 may also refer customer 202 to financial institution 240 to obtain a loan with which to purchase the price protection services. Financial institution 240 can analyze its customer base to identify existing customers 202 of financial institution 240 (with, in some embodiments, good credit or heavy consumption of the price-protected commodity) and suggestion to these customers 202 that they purchase the price protection services.

In one embodiment a customer 202 may be offered a price protection contract which encompasses both a price protection contract providing price protection, such as that discussed above, and a loan or line of credit from financial institution 240. In some embodiments, a price protection contract for price protection may be provided to a customer 202 such that customer 202 obtains price protection for 1000 gallons of fuel for a time period of a year at a lock price. In this embodiment, customer 202 can prepay for 200 gallons at the lock price, while the other ten months may be covered by a loan from financial institution 240. Financial institution 240 (which provides the line of credit to the customer 202 in this embodiment) may pay for the remaining ten months to the operators of price protection system 220 immediately. The operators of price protection system 220 may then sign a full recourse loan to financial institution 240, while the customer 202 pays interest on the ten-month loan and is contracted with financial institution 240 for the loan.

Irrespective of the method used to pay for costs associated with obtaining the price protection contract, the upfront costs (if any) may be paid at step 310. In some embodiments trust 260 arrangement is created at step 312. A portion of the proceeds of the financing package obtained at step 308 may be used to establish trust 260 in which financial institution 240 may be given a security interest to collateralize the financing package. A virtual reserve corresponding to the terms of the price protection contract may be established at step 314 including reconciling any resources associated with the reserve or customer 202 (if customer 202 has another account with price protection system 220 the accounts may be balanced or other adjustments made in some embodiments). Customer 202 may also set any variables associated with the reserve. In some embodiments, customer 202 may choose a price tolerance to be added to the lock price such that the virtual reserve is not depleted unless the retail price exceeds the sum of the lock price and the price tolerance.

The operators of price protection system 220 may move the “risk” associated with their providing the price protection contract to financial institution 240 at step 316. The price protection contract provided by operators of price protection system 220 may specify a quantity, a locale, a lock price, a time period and a grade of fuel. Thus, by providing this price protection contract the operators of price protection system 220 may have agreed to reimburse the owner of this price protection contract for any amount paid for fuel over the lock price for any fuel purchased in the locale during the time period up to the specified quantity. To offload the “risk” assumed by providing this price protection contract (the possibility that operators of price protection system 220 will have to pay reimbursement under the provided price protection contract in some embodiments), the operators of price protection system 220 may themselves purchase or otherwise obtain a right of indemnification from financial institution 240.

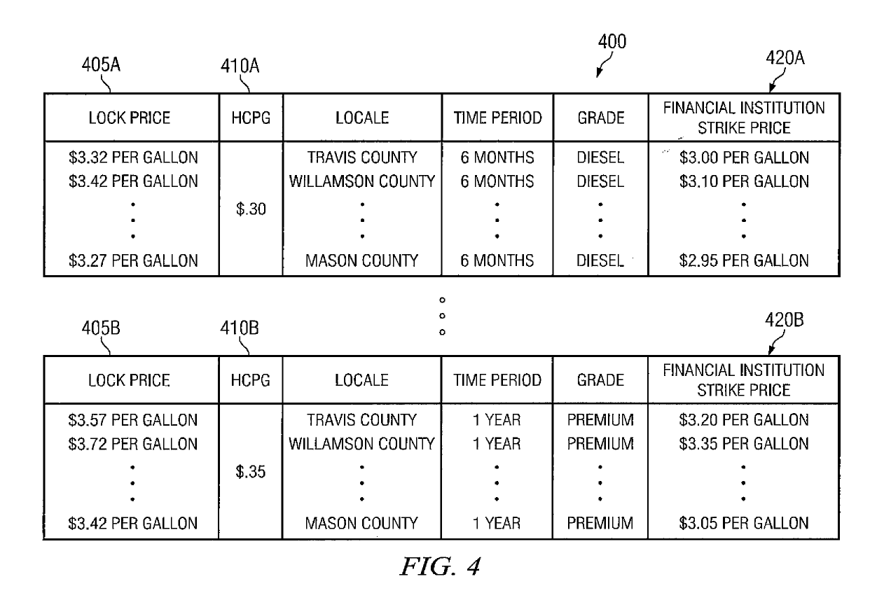

The parameters of the right of indemnification obtained by operators of price protection system 220 from financial institution 140 may depend on a number of factors including the risk adversity of the operators of price protection system 220 (how much risk the operators of price protection system 220 wish to take on in some embodiments). Thus, at least a portion of the risk inherent in providing a price protection contract may be offset by purchasing the right to be indemnified by financial institution 240 for any amount paid for a specified quantity of a grade of fuel over a financial institution strike price 420 (see FIG. 4). The indemnification may be obtained by paying a fee 410 for it (a hedge cost per gallon or HCPG fee in some embodiments) to financial institution 240 for the specified quantity.

Referring to FIG. 4, a financial institution strike price matrix 400 is illustrated Financial institution strike prices 420A and 420B, illustrated in FIG. 4, can correspond to the prices per unit of the commodity at which the financial institution has the right to buy the commodity via a security such as an option on the commodity. In some embodiments, lock prices 405A and 405B may be a price or a range of prices that purchaser 101 has agreed to pay for the commodity if the retail price of the commodity rises above the lock price. However, if the retail price of the commodity falls below the corresponding lock price 405A and 405B the consumer may purchase the commodity at the retail price. In some embodiments, lock prices 405A and 405B may be based on an index or may be determined by price protection system 220. Matrix 400 lists HCPGs 410 for various types of commodities along with the parameters which might influence the selection of an HCPG 410. In some embodiments, matrix 400 shows two sets of HCPGs 410A and 410B for, respectively diesel fuel and premium gasoline. Matrix 400 also shows two sets of financial institution strike prices 420A and 420B associated with the sets of HCPGs 410A and 410B. The parameters (of quantity, grade, locale, and time period) associated with the indemnification obtained by operators of price protection system 220 from financial institution 240 may correspond to the parameters of the price protection contract provided to customer 202. Financial institution strike price 420 which is associated with the right of indemnification (obtained from financial institution 240 by operators of price protection system 220) may correspond to financial institution strike price 420 from which the lock prices 405A and 405B associated with the customer 202 price protection contract was calculated. In some embodiments, lock prices 405A and 405B can reflect an addition of all or a portion of HCPGs 410A and 410B to strike prices 420A and 420B along with a mark up or mark down as may be desired.

Again, the disclosure of an embodiment may be helpful. Suppose that financial institution strike price matrix 400 is provided to price protection system 220 by financial institution 240. From financial strike price matrix 400, price protection system 220 may determine a price protection contract comprising price protection for 100 gallons of diesel in Travis County for a period of six months at a lock price of $3.50 per gallon. If customer 202 decides to obtain this price protection contract, operators of price protection system 220 may obtain a right of indemnification covering the purchase of 100 gallons of diesel in Travis County for six months at a financial institution strike price 420 of $3.00 per gallon from financial institution 240 by paying $300 (HCPG 420 of $0.30 for 100 gallons in some embodiments). In the next six months then, whenever diesel is purchased by customer 202 (a fleet driver associated with customer 202 in some embodiments) in Travis County at a price above $3.50 customer 202 may obtain reimbursement for any amount over the $3.50 lock price associated with the obtained price protection contract for each gallon of diesel purchased up to 100 gallons. Operators of price protection system 220 may obtain reimbursement from financial institution 240 for any amount over the $3.00 per gallon financial institution strike price 420 for each gallon of diesel purchased up to 100 gallons.

At step 318 of FIG. 3, customer 202 may obtain quantities of the price-protected commodity (gasoline in some embodiments) as customer 202 desires and according to the terms of the price protection contract selected at step 307 including the lock price associated therewith. When customer 202 exercises the contractual right to obtain the price protected commodity at the lock price (when the retail price is above the lock price in some embodiments) system 200 may draw from trust 260 to pay for the purchase (up to the lock price after which price protection system 220 may be responsible for payment) at step 320.

Method 300 may also provide for customer 202 to service the loan at step 322 in accordance with the provisions of the financing package. System 200 may be configured to determine whether customer 202 defaults on the loan at step 324. If customer 202 continues to service the loan, method 300 allows customer 202 to continue obtaining the price protected commodity at step 318. If customer 202 defaults, though, system 200 may be configured to deny customer 202 access to the price-protected commodity at step 326. System 200 may also be configured to remit any funds associated with customer 202 in trust 260 to financial institution 240 at step 328. Financial institution 240 and price protection service provider 220 may pursue other remedies against defaulting customer 202 in some embodiments.

System 200 can be configured such that customer 202 can continue obtaining the price protected commodity until the end of the contract or until the customer's reserve is depleted as indicated by steps 330 and 332 respectively. If the end of the contract approaches and customer 202 has some portion of customer's 202 reserve left over, some embodiments allow customer 202 to rollover the un-used portion of the reserve to another contract at step 334. Such scenarios may happen when the retail price remains below the lock price for the duration of the contract. Some embodiments allow customer 202 to accept a novation of the contract at step 334. In either case, method 300 may return to steps 307 and 308 to allow a new contractual arrangement to be made between the parties 202, 220, and 240. In some embodiments, a customer 202 with an un-used reserve (or a portion thereof) may obtain a refund from price protection system 220 or trust 260. In some embodiments, customer 202 may obtain a rollover, novation, or refund if customer 202 wishes to dispose of the contract.

Suppose that on the day the price protection contracts expires the contract is worth $100 (the product of the amount of fuel in the reserve multiplied by the difference between the prevailing retail price and the lock price equals $100 in some embodiments). In one embodiment, price protection system 220 may provide a contract novation in which operators of price protection system 220 will purchase the price protection contract at some fraction (which may be one half in some embodiments) of the then prevailing value. In this embodiment, the customer's pre-payment (in this example, $200) is refunded from the trust account 260 held at investment partner 246 less a fee (in this example, $50) charged to the consumer for the contract novation. System 200 may also be configured such that financial institution 240 remits to the operators of price protection system 220 the insurance fee related to the indemnification obtained from financial institution 240 by operators of price protection system 220 (in this example, $75). Thus, operators of price protection system 220 may have a $25 profit margin under this scenario.

Although various embodiments have been described in detail herein with reference to the illustrated embodiments, it should be understood that the disclosure is by way of example only and is not to be construed in a limiting sense. It is to be further understood, therefore, that numerous changes in the details of the embodiments and additional embodiments will be apparent, and may be made by, persons of ordinary skill in the art having reference to this description. It is contemplated that all such changes and additional embodiments are within scope of the disclosure as claimed below.

What is claimed is:

1. A computer implemented method comprising:
enabling a price protection service provider to specify a forward position associated with a retail commodity in a retail commodity price protection contract;
enabling a customer to select a payment option from a plurality of payment options, wherein the plurality of payment options includes a loan wherein covers at least a portion of the cost of the retail commodity price protection contract; and
creating a financial instrument associated with the retail commodity price protection contract between the price protection service provider and the customer based on the payment option selected by the customer.

2. The method of claim 1, further comprising creating a trust with at least a portion of the proceeds of the loan.

3. The method of claim 2, further comprising creating a security interest in the trust for a lender of the loan.

4. The method of claim 3, wherein the lender is a financial institution other than the price protection service provider.

5. The method of claim 3, wherein the price protection service provider is the lender.

6. The method of claim 1, further comprising enabling the customer to select an action from the group consisting of rolling over an un-used portion of the price protection service, receiving a refund for the un-used portion of the price protection service, and novating the un-used portion of the price protection service.

7. The method of claim 1, wherein the customer is an individual consumer.

8. The method of claim 1, wherein the customer represents an entity.

9. The method of claim 1, further comprising determining whether to include the loan as one of the plurality of payment options, wherein the determining step comprises analyzing a consumption pattern of the retail commodity by the customer.

10. The method of claim 9, wherein the determining step further comprises determining whether the customer has a cash flow position affected by the price of the retail commodity.

11. The method of claim 9, wherein the determining step further comprises assessing a credit risk of the customer.

12. A computer readable medium carrying program instructions executable by a processor to:
enable a price protection service provider to specify a forward position associated with a retail commodity in a retail commodity price protection contract;
enable a customer to select a payment option from a plurality of payment options, wherein the plurality of payment options includes a loan wherein covers at least a portion of the cost of the retail commodity price protection contract; and
create a financial instrument associated with the retail commodity price protection contract between the price protection service provider and the customer based on the payment option selected by the customer.

13. The computer readable medium of claim 12, wherein the loan is serviced by a financial institution other than the price protection service provider.

14. The computer readable medium of claim 12, wherein the loan is serviced by the price protection service provider.

15. The computer readable medium of claim 12, wherein the program instructions are further executable by the processor to enable the customer to select an action from the group consisting of rolling over an un-used portion of the price protection service, receiving a refund for the un-used portion of the price protection service, and novating the un-used portion of the price protection service.

16. The computer readable medium of claim 12, wherein the program instructions are further executable by the processor to analyze a consumption pattern of the retail commodity by the customer.

17. The computer readable medium of claim 12, wherein the program instructions are further executable by the processor to assess a credit risk of the customer.

18. A system comprising:
a processor; and
a computer readable medium carrying program instructions executable by a processor to:
enable a price protection service provider to specify a forward position associated with a retail commodity in a retail commodity price protection contract;
enable a customer to select a payment option from a plurality of payment options, wherein the plurality of payment options includes a loan wherein covers at least a portion of the cost of the retail commodity price protection contract; and
create a financial instrument associated with the retail commodity price protection contract between the price protection service provider and the customer based on the payment option selected by the customer.

19. The system of claim 18, wherein the loan is serviced by a financial institution other than the price protection service provider.

20. The system of claim 18, wherein the loan is serviced by the price protection service provider.
